(19) United States
(12) Patent Application Publication
(10) Pub. No.: US 2008/0233291 A1
(43) Pub. Date: Sep. 25, 2008

(54) Method for depositing an inorganic layer to a thermal transfer layer

(76) Inventor: Casey K. Chandrasekaran, Kennett Square, PA (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(21) Appl. No.: 11/726,838

(22) Filed: Mar. 23, 2007

(51) Int. Cl. B05D 3/06

(52) U.S. Cl. 427/299

(57) ABSTRACT

The invention is a method for depositing an inorganic layer to a laser-induced thermal transfer layer, and to a deposited transfer layer made by the method. In one embodiment, the transfer layer is disposed on a receiver element comprising a glass substrate with black matrix for a color filter comprising red, blue and green transparent pixels formed by laser-induced thermal transfer, and the inorganic layer is an indium-tin oxide transparent electrode grounding layer. The method for depositing the inorganic layer to the transfer layer comprises exposing a laser-induced thermal transfer layer to ultraviolet radiation to produce an exposed transfer layer, treating the exposed transfer layer with a cleaning fluid to produce a cleaned transfer layer, and depositing an inorganic layer in contact with the cleaned transfer layer to produce a deposited transfer layer.

### FIELD OF THE INVENTION

The invention pertains to a process for manufacture of devices having a metal oxide layer contacting a laser-induced thermal transfer layer, for example electronic devices having a transparent conductor layer contacting a laser-transferred organic layer comprising a binder, e.g. a color filter with a thermal transfer layer including binder and pigment contacting a transparent conducting layer of indium-tin oxide.

### BACKGROUND OF THE INVENTION

Devices such as color filters, light-emitting diodes, and microelectronics can have multilayer structures subject to strict performance criteria such as color, transparency, flatness, conductivity, and interlayer adhesion. There remains a need to improve the methods of manufacturing devices having multilayer structures.

For example, it is well known that devices containing layered material with different coefficients of thermal expansion (CTE), including coefficients of linear thermal expansion, can fail under circumstances of changing temperature due to strain, wrinkling, delamination, delamination under stress, or other failure modes. This situation is common when a polymer layer and a metal-containing layer are joined, since polymers have a CITE about 10 times higher than metals (e.g., the CTE of polymethyl methacrylate is about 0.000 07/K, the CTE of polystyrene is about 0.000 09/K, and the CTE of indium-tin oxide (ITO) is about 0.000 009/K).

Ultraviolet (UV) light is electromagnetic radiation with a wavelength shorter than that of violet light (thus <˜400 nm), but longer than most soft X-rays. It can be subdivided into near UV (˜380 to ˜200 nm wavelength), far or vacuum UV (˜200 to ˜10 nm;), and extreme UV (˜1 to ˜31 nm).

When considering the effect of UV radiation on human health and the environment, the range of UV wavelengths is often subdivided into UVA (380-315 nm); UVB (315-280 nm); and UVC (<280 nm), also called short wave or “germicidal”.

In an atmosphere containing diatomic oxygen, ultraviolet wavelengths more energetic than 242 nm can be absorbed by diatomic oxygen to form two atoms of atomic oxygen. The energetic atomic oxygen can combine with a diatomic oxygen to form ozone, or can react with an organic compound. The ozone can absorb ultraviolet wavelengths more energetic than 310 nm to produce diatomic oxygen and an oxygen atom, or can react with an organic compound. The sum of atomic oxygen and ozone can be decreased by the reaction of atomic oxygen and ozone to give 2 molecules of diatomic oxygen.

A common source of UV radiation is a lamp comprising mercury vapor (termed a mercury lamp), that can be electrically induced to emit UV radiation with local energy maximums near 253.7 nm, and 185 nm.

U.S. Pat. No. 6,242,140 of Kwon et al. to Samsung (incorporated by reference) discloses manufacture of a device useful as a color filter by a method including providing a glass substrate, cleaning (with a cleaning solution based on ET-cold, Environmental Tech., U.S.A.) the substrate, ultraviolet treating and annealing the cleaned substrate, forming a black matrix pattern on the annealed substrate, cleaning the black matrix patterned substrate, ultrasonically treating the clean black matrix patterned substrate, ultraviolet treating and annealing the ultrasonically treated black matrix patterned substrate, forming red, green, and blue color filter layers on the annealed black matrix patterned substrate using sequentially red, green, and blue transfer films imaged by a laser beam, curing the red, green and blue color filter patterns at approximately 250° C. for 1 hour, cleaning the cured red, green, and blue patterned substrate, ultrasonically treating the clean red, green, and blue patterned substrate, ultraviolet treating and annealing the ultrasonically treated red, green, and blue patterned substrate, and batch-type sputtering an indium-tin oxide layer of 7-8 ohms/square on the red, green, and blue patterned substrate. Also disclosed was a method of manufacturing a color filter comprising: forming a black matrix pattern on a substrate by photolithography; placing a transfer film having thermal color layers on the substrate; irradiating the transfer film with a complex laser beam formed of unit laser beams having different energy intensities to transfer the color layers to the substrate; and curing the substrate onto which the color layers have been transferred, at 200-300° C., wherein a surface of the substrate is treated by irradiation with ultraviolet light and/or with ozone, or a surfactant, before and after forming the black matrix pattern and transferring the color layers. Ultraviolet treatment conditions and annealing conditions were basically unspecified. Preferably, a surface of the substrate is treated with UV rays and/or ozone or a surfactant, before and after forming the black matrix layer, the color filter layer, the transparent electrode layer and the buffer (silicon dioxide) layer.

U.S. Pat. No. 6,004,704, titled as a “METHOD OF MAKING A COLOR FILTER APPARATUS” by Byung Soo Ko, assigned to LG. Philips LCD Co.; Ltd. (incorporated by reference) discloses a method of making a color filter apparatus comprising the steps of providing a transparent substrate; forming first, second and third color filters on the transparent substrate while intermittently performing a step of curing the first, second and third color filters to harden the first, second and third color filters and a step of surface treating an upper portion of the transparent substrate between the steps of forming the first, second and third color filters, wherein said step of surface treating includes irradiating an infrared light and an ultraviolet light onto the upper portion of the transparent substrate so as to remove a residual portion of the material used to form the first, second and third color filters. It is also disclosed that it will be apparent to the skilled person in the art that both an infrared ray and an ultraviolet ray are irradiated in order to provide the surface treatment of the glass substrate and the filters in the present preferred embodiment, but the glass substrate and the filters can be surface-treated using only one of the infrared and ultraviolet rays. No significant characterization is provided of the ultraviolet light used. The color filter layers are formed using resist film.

U.S. Pat. No. 6,177,215, titled “MANUFACTURING METHOD OF A COLOR FILTER SUBSTRATE”, by Jung et al., assigned to Samsung Electronics Co.; Ltd. (incorporated by reference) disclose that traces of moisture, gas or pigment residue remaining in color filters or on the surfaces of the black matrix of a color filter are removed by executing I.R. and U.V. ashing on the surfaces of the black matrix and the color filters before forming the ITO layer. Accordingly, the quality of a liquid crystal display is improved by reinforcing the adhesive strength of the color filters and the black matrix, to the ITO layer. Any separation between the two substrates, or detachment of the ITO layer from the color filters and the black matrix disappear. Furthermore, contact resistance between the ITO layer and the black matrix is reduced by removing any pigment residue on the surface of the black matrix. Also disclosed is that ozone molecules can be injected into the U.V. chamber in the U.V. irradiation procedure. Any residual traces of pigment remaining on the surface of the black matrix are dissolved and volatilized in reaction to active oxygen from ozone. Color filter layers were provided using negative photoresists. No significant characterization is provided of the ultraviolet light used.

U.S. Pat. No. 5,482,803 by Ishiwata, et al. to Canon Kabushiki Kaisha (incorporated by reference) discloses a process for preparing a photosensitive resin filter composed mainly of at least one of a polyimide resin or a polyamide resin, comprising the sequential steps of: applying the resin to a substrate surface; subjecting the applied resin to light exposure and development by photolithography; irradiating the substrate surface with an ultraviolet ray having an irradiation energy within the range of 2 to 20 J/cm in an oxygen-containing atmosphere so as to remove development residue remaining on the substrate surface; and baking the resin. An ITO film and a metallic film as an auxiliary electrode were each formed on the thus prepared substrate by sputtering. Irradiation with the UV ray after the development and before the postbaking requires less energy for the decomposition and removal of the residue components than that after the postbaking and can more readily decompose and remove the residue components uniformly all over the entire substrate surface. It is desirable to select an irradiation energy level of ultraviolet (UV) ray to the substrate surface in view of the state of residues to be removed or the state of the resin to remain. Thus, generally it is preferable to select an irradiation energy level of 2 to 20 J/cm when the resin patterned on the substrate surface before postcuring and an irradiation energy level of 5 to 20 J/cm after the postcuring. However, the irradiation energy level is adjustable, when required, as mentioned above. If the irradiation energy level is too low, the residues to be removed cannot be removed, whereas if it is too high, there is a high possibility to damage the patterned resin to a greater extent than required. Thus, the irradiation energy level must be carefully selected. A UV ray of any wavelength can be used for the irradiation, so far as it can activate the oxygen in the air or the oxygen-containing atmosphere. Specifically, an applicable wavelength range for the UV ray is 150 nm to 400 nm. Any light source for the UV ray irradiation can be used, so far as it contains the wavelength component in the above-mentioned range, and includes, for example, lasers such as an eximer laser such as KrF laser, ArF laser, XeCI laser, XeF laser, etc., YAG laser, etc., and discharge lamps such as Xenon-arc lamp, mercury lamp, arc lamp, fluorescent chemical lamp, black light fluorescent lamp, etc.

U.S. Pat. No. 5,956,109, titled a “METHOD OF FABRICATING COLOR FILTERS USED IN A LIQUID CRYSTAL DISPLAY”, by Sung Ki Jung to Samsung Electronics Co.; Ltd. (incorporated by reference) discloses a method of fabricating color filters used in an LCD, comprising the steps of: forming a black matrix on a glass substrate, sequentially forming a first, second and third color filter layer between parts of the black matrix, removing pigment residue from the black matrix by a U.V. ashing process, and forming a transparent electrode layer such as indium-tin oxide over the color filter layers. No significant characterization is provided of the ultraviolet light used.

A color filter irradiated by UV radiation prior to ITO deposition is disclosed by U.S. Pat. No. 5,166,126 by Daniel J. Harrison, et al. to Eastman Kodak Company (incorporated by reference).

A method of manufacturing a liquid crystal display device containing a color filter comprising a black matrix and associated with a common electrode comprising a metal is disclosed in U.S. Pat. No. 7,113,248 by Chung et 31. assigned to L.G. Philips LCD Co, Ltd (incorporated by reference).

### SUMMARY OF THE INVENTION

The invention comprises a method for depositing an inorganic layer to a laser-induced thermal transfer layer, and to a deposited transfer layer made by the method. In one embodiment, the transfer layer is disposed on a receiver element comprising a glass substrate with black matrix for a color filter comprising red, blue and green transparent pixels formed by laser-induced thermal transfer, and the inorganic layer is an indium-tin oxide transparent electrode grounding layer. The method for depositing the inorganic layer to the transfer layer comprises exposing the transfer layer to ultraviolet radiation to produce an exposed transfer layer, treating the exposed transfer layer with a cleaning fluid to produce a cleaned transfer layer, and depositing an inorganic layer in contact with the cleaned transfer layer to produce a deposited transfer layer.

### BRIEF DESCRIPTION OF THE DRAWINGS

FIG. 1 is a cross sectional view of a color filter having transfer layers, coated with an inorganic layer of indium-tin oxide.

FIGS. 2A, 2B and 2C are cross sectional views of representative thermal transfer donor elements.

FIG. 3 is a cross sectional view of an assemblage comprising a thermal transfer donor element and a receiver element, undergoing imaging by a beam of laser light.

FIG. 4 is a cross sectional view showing a disassembled imaged assemblage of FIG. 3 after imaging.

FIG. 5 is a cross sectional view showing a receiver element and three types of transfer layer, imaged onto the receiver from three different donor elements used in separate assemblages.

### DETAILED DESCRIPTION OF THE PREFERRED EMBODIMENT(S)

The present invention utilizes a cleaning step to treat an ultraviolet (UV) exposed laser-induced thermal transfer layer prior to deposition of an inorganic layer (e.g. indium-tin oxide) onto and in contact with the laser-induced thermal layer, especially using a suitable wavelength range and energy range of ultraviolet radiation. One theory that could explain the usefulness of the cleaning step is that the cleaning can remove residues caused by the UV exposure. It is believed that the UV exposure of a layer of organic compound(s) such as a binder, especially in the presence of oxygen and UV generated ozone and atomic oxygen, acts to break chemical bonds, create carboxylic acids and carbon dioxide, and crosslink especially the upper most layer exposed. It is believed that the crosslinking creates a layer that is more resistant to wrinkling typically occurring when temperature changes experienced by a transfer layer and an attached inorganic layer produce different amounts of dimensional change of those layers due to different coefficients of thermal expansion. However, some of the other new chemical species on the surface are believed to be detrimental to adhesion between the transfer layer and the attached inorganic layer. A cleaning step is believed to remove new chemical species generated by the ultraviolet exposure step while leaving the crosslinked species behind.

An embodiment of the present invention is the manufacture of an indium-tin oxide coated color filter comprising red, green, and blue light-passing pixels made using thermal mass transfer of transfer layers. FIG. 1 shows such an indium-tin oxide coated color filter.

In FIG. 1, the indium-tin oxide coated color filter (10) comprises a transparent glass substrate (20) having an opaque black matrix (30) delineating pixels that selectively pass light by wavelength, covered by red transfer layer (40R), or blue transfer layer (40B), or green transfer layer (40G), so as to filter out the other colors of white light when such light passes through each respective pixel. A layer of indium-tin oxide (50) covers and contacts the glass, the transfer layers, and the black matrix.

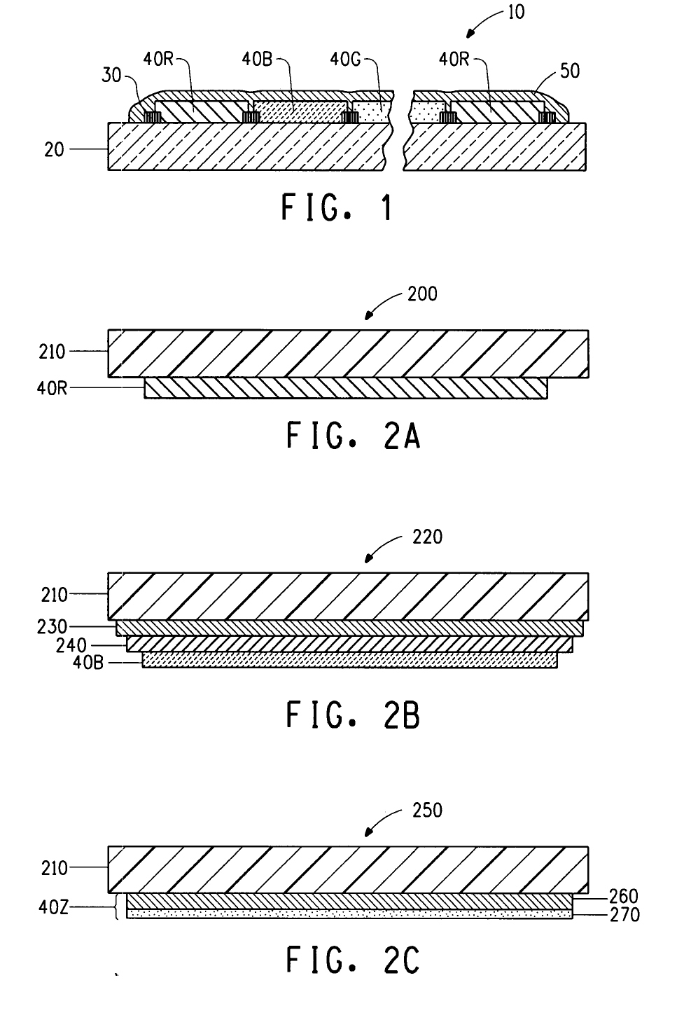

The transfer layers (40R, 40B, 40G) of FIG. 1 each come from a larger portion of transfer layer on a donor element (e.g. 200, 220, 250) of FIG. 2, through a transfer process to a single receiver element, in this case the transparent glass substrate (20) having an opaque black matrix (30).

FIG. 2A shows a simple two-layer donor element (200) having a support layer (210) and a transfer layer (40R). FIG. 2B shows a four-layer donor element (220) having a support layer (210), a light-to-heat-conversion (LTHC) layer (230), an interlayer (240) and a transfer layer (40R). FIG. 2C shows a three layer donor element having a support layer (210) and a transfer layer (40Z), where the transfer layer is itself composed of two sublayers, a colored layer (260) and an adhesive layer (270).

The donor element is composed of layers. Suitable techniques for forming the layers include, for example, chemical and physical vapor deposition, extrusion, casting, sputtering, spin coating, roll coating, and other film coating methods.

The donor support layer provides a support for the other layers of the thermal transfer donor element, and to allow handling of the donor element during assemblage construction, manipulation, and separation. The donor support layer for the thermal transfer element can be a polymer film. One suitable type of polymer film is a polyester film, for example, polyethylene terephthalate or polyethylene naphthalate. Biaxially stretched polyethylene terephthalate is preferred from the viewpoint of economy, mechanical strength and dimensional stability against heat. Films of polyamides; polycarbonates; cellulose esters such as cellulose acetate; fluorine polymers such as poly(vinylidene fluoride) or poly(tetrafluoroethylene-co-hexafluoropropylene); polyethers such as polyoxymethylene; polyacetals; polyolefins such as polystyrene, polyethylene, polypropylene or methylpentene polymers; and polyimides such as polyimide-amides and polyether-imides can also be suitable. Other films with sufficient properties, for example high transmission of imaging laser light at a particular wavelength for imaging through the support layer, and sufficient mechanical and thermal stability for the particular application, can be used. The donor support layer, in at least some instances, is flat so that uniform coatings can be formed. The donor support layer is also typically selected from materials that remain stable despite heating of any layers in the thermal transfer donor element (e.g., a light-to-heat conversion (LTHC) layer). A suitable thickness for the donor support layer ranges from, for example, 0.025 to 0.15 mm, preferably 0.05 to 0.1 mm, although thicker or thinner donor support layers may be used.

The transfer layer typically includes all of the layers and sublayers that can be or are transferred from the donor element as the result of laser illumination. The transfer layer can include a single layer or multiple (sub)layers. In one embodiment, one of these layers is a binder-containing layer. Layers of the transfer layer can be formed using a variety of configuration and materials, including those described, for example, in U.S. Pat. Nos. 5,156,938; 5,171,650; 5,244,770; 5,256,506; 5,387,496; 5,501,938; 5,521,035; 5,593,808; 5,605,780; 5,612,165; 5,622,795; 5,685,939; 5,691,114; 5,693,446; and 5,710,097, incorporated herein by reference.

The transfer layer is formulated to be appropriate for the corresponding imaging application (e.g., color filters). The transfer layer may itself be comprised of a thermoplastic and/or thermoset binder. In many product applications (for example, in printing plate and color filter applications) the transfer layer comprises materials that are preferably crosslinked after imaging in order to improve performance of the imaged product. The crosslinking can involve a heating step or an irradiation step that creates the crosslinks. In one embodiment, the binder comprises a plurality of crosslinkable functional groups that react with crosslinking functionality. Some suitable pairs of functionality for the crosslinking reactions include: hydroxyl and isocyanate; hydroxyl and carboxyl; N-2-hydroxyethyl amide and carboxyl; hydroxyl and melamine-formaldehyde; carboxyl and melamine-formaldehyde; carboxyl and amine; carboxyl and epoxy, epoxy and amine; and carboxylic anhydride and amine. The hydroxyl/carboxyl, N-2-hydroxyethyl amide/carboxyl, epoxy/carboxyl and melamine-formaldehyde/carboxyl pairs are particularly effective since common aqueous-dispersed binders and aqueous pigment dispersants contain carboxyl groups which can be incorporated as reactants into the final crosslinked polymer matrix. The pairs of crosslinking functional groups can be utilized in several ways. One crosslinking functional group can be incorporated into the binder polymer backbone, and the other added as a polyfunctional low molecular weight crosslinking agent. One crosslinking functional group can be incorporated into the binder polymer backbone, and the other incorporated into a different binder polymer backbone. Both of the crosslinking functional groups can be incorporated into the same binder polymer backbone. In binders manufactured by processes such as free radical polymerization, monomers such as acrylic acid, methacrylic acid, 2-hydroxyethyl acrylate, 2-hydroxypropyl acrylate, 2-hydroxyethyl methacrylate, and 2-hydroxypropyl methacrylate can provide carboxyl or hydroxyl functionality. In crosslinkers, compounds such as N,N,N′,N′-tetrakis (2-hydroxyethyl)-hexanediamide (Primid XL-552, EMS American Grilon, Sumter, S.C.) provide four instances of N-2-hydroxyethyl amide functionality, a specialized hydroxyl group, and pentaerythritol and dipentaerythritol provide instances of hydroxyls as well, all suitable for crosslinking with carboxyl functionality.

Other additives included in the transfer layer can be specific to the end-use application (e.g., colorants for color proofing and color filter applications, photoinitiators for photo-crosslinked or photo-crosslinkable transfer layers, etc.,) and are well known to those skilled in the art. Two classes of colorants are common: pigments and dyes. In one embodiment, the transfer layer comprises at least one pigment.

The thermal transfer layer may comprise classes of materials including, but not limited to dyes (e.g., visible dyes, ultraviolet dyes, fluorescent dyes, radiation-polarizing dyes, IR dyes, etc.), optically active materials, pigments (e.g., transparent pigments, colored pigments, black body absorbers, etc.), magnetic particles, electrically conducting insulating particles, liquid crystal materials, hydrophilic or hydrophobic materials, initiators, sensitizers, phosphors, polymeric binders, enzymes, etc. For many applications such as color proofing and color filter elements, the thermal transfer layer will comprise colorants. Preferably the thermal transfer layer will comprise at least one organic or inorganic colorant (i.e., pigments or dyes) and a thermoplastic binder. Other additives may also be included such as an IR absorber, dispersing agents, surfactants, stabilizers, plasticizers, crosslinking agents and coating aids. Any pigment may be used, but for applications such as color filter elements, preferred pigments are those listed as having good color permanency and transparency in the NPIRI Raw Materials Data Handbook, Volume 4 (Pigments) or W. Herbst, Industrial Organic Pigments, VCH, 1993. Either non-aqueous or aqueous pigment dispersions may be used. The pigments are generally introduced into the color formulation in the form of a millbase comprising the pigment dispersed with a binder and suspended into a solvent or mixture of solvents. The pigment type and color are chosen such that the color coating is matched to a preset color target or specification set by the industry. The type of dispersing resin and the pigment-to-resin ratio will depend upon the pigment type, surface treatment on the pigment, dispersing solvent and milling process used in generating the millbase. Suitable dispersing resins include vinyl chloride/vinyl acetate copolymers, poly(vinyl acetate)/crotonic acid copolymers, polyurethanes, styrene maleic anhydride half ester resins, (meth)acrylate polymers and copolymers, poly(vinyl acetals), poly(vinyl acetals) modified with anhydrides and amines, hydroxy alkyl cellulose resins and styrene acrylic resins. A preferred color transfer coating composition comprises 30-80% by weight pigment, 15-60% by weight resin, and 0-20% by weight dispersing agents and additives.

The amount of binder present in a pigmented transfer layer can be kept to a minimum to avoid loss of image resolution and/or imaging sensitivity due to excessive cohesion in the transfer layer. The pigment-to-binder ratio is typically between 10:1 to 1:10 by weight depending on the type of pigments and binders used. The binder system may also include polymerizable and/or crosslinkable materials (i.e., monomers, oligomers, prepolymers, and/or polymers) and optionally an initiator system. Using monomers or oligomers assists in reducing the binder cohesive force in the pigmented transfer layer, therefore improving imaging sensitivity and/or transferred image resolution. Incorporation of a crosslinkable composition into the transfer layer allows one to produce a more durable and solvent resistant image. A highly crosslinked image is formed by first transferring the image to a receiver element and then exposing the transferred image to radiation, heat and/or a chemical curative to crosslink the polymerizable materials. In the case where radiation is employed to crosslink the composition, any radiation source can be used that is absorbed by the imaged transfer layer.

The transfer layer typically includes a binder composition. The binder composition typically includes one or more binders. The binder composition optionally includes other additives such as, for example, dispersing agents, surfactants, stabilizers, crosslinking agents, photocatalysts, photoinitiators, and/or coating aids.

In one embodiment, the transfer layer is not subjected to a polymerization step, e.g. a reaction initiated by photocatalysts, photoinitiators, free radical photoinitiation or free radical thermal initiation of free radical monomers, or other polymerizable groups, that consumes double bonds and produces polymer bonds. In one such embodiment, the transfer layer is practically free (less than 2% by weight) of such ingredients intended for polymerization as polymerizable molecules with two or more instances of polymerizable functions (e.g. ethylene glycol dimethacrylate, hexamethylene diacrylate, divinyl benzene, and glycerol triacrylate, and others including those practical for photolithography). In another embodiment, the transfer layer is practically free (less than one of 5.0, 1.0, 0.5, and 0.1% by weight) of such ingredients commonly used to initiate or transfer polymerization (e.g. benzoin, isopropyl thioxanthone, thiols, etc.). In one embodiment, the transfer layer is not subjected to an imagewise polymerization step, as is common for photoresists, nor to an imagewise development that preferentially removes only one of imaged or unimaged transfer layer.

The binder of the binder composition gives structure to the layer. In one embodiment, at least one of these binders (and, in some embodiments, all of the binders) are polymerizable or crosslinkable. A binder may be crosslinkable by virtue of having at least two carboxylic acid groups. A variety of binders can be used including, for example, monomeric (e.g. polymerizable), oligomeric (e.g. weight average molecular weight less than 5000 atomic mass units), and polymeric binders. Suitable binders for use in the transfer layer include film-forming polymers, such as, for example, phenolic resins (e.g., novolak and resole resins), polyvinyl butyral resins, polyvinyl acetates, polyvinyl acetals, polyvinylidene chlorides, polyacrylates, cellulosic ethers and esters, nitrocelluloses, (meth)acrylate polymers and copolymers, epoxy resins, ethylenic-unsaturated resins, polyesters, polysulphones, polyimides, polyamides, polysulphides, and polycarbonates.

Dispersing agents can be used, particularly if some of the components of the layer are non-compatible. Suitable dispersing agents include, for example, vinyl chloride/vinyl acetate copolymers, poly(vinyl acetate)/crotonic acid copolymers, polyurethanes, styrene maleic anhydride half ester resins, (meth)acrylate polymers and copolymers, poly(vinyl acetals), poly(vinyl acetals) modified with anhydrides and amines, hydroxy alkyl cellulose resins, styrene acrylic resins, nitrocellulose, and sulfonated polyesters.

The transfer layer may be applied by any conventional coating method known in the art. It may be desirable to add coating aids such as surfactants and dispersing agents to provide a uniform coating. Preferably, the layer has a thickness from about 0.05 to 10.0 micrometers, more preferably from 0.5 to 4.0 micrometers.

The donor element of the present invention is not limited to those having a single homogeneous support layer and transfer layer. Other layers can be disposed in the donor element, and a layer need not be homogeneous but may be composed of sublayers or a combination of layers, as illustrated in FIG. 2.

For example, a support layer can include an (outer) antistatic layer, a main support layer, and an (inner) adhesion modifying layer, each disposed adjacently more closely to the transfer layer.

The outer antistatic layer may comprise a binder and an anitstatic layer. As the antistatic agents for use in the antistatic layer, a nonionic surfactant, e.g., polyoxyethylene alkylamine, and glycerol fatty acid ester; a cationic surfactant, e.g., a quaternary ammonium salt; an anionic surfactant, e.g., alkylphosphate; an ampholytic surfactant and electrically conductive resin can be exemplified. As an antistatic layer binder, homopolymers and copolymers of acrylic acid-based monomers, e.g., acrylic acid, methacrylic acid, acrylic ester and methacrylic ester, cellulose-based polymers, e.g., nitrocellulose, methyl cellulose, ethyl cellulose and cellulose acetate, vinyl-based polymers and copolymers of vinyl compounds, e.g., polyethylene, polypropylene, polystyrene, vinyl chloride-based copolymer, vinyl chloride-vinyl acetate copolymer, polyvinyl pyrrolidone, polyvinyl butyral and polyvinyl alcohol, condensed polymers, e.g., polyester, polyurethane and polyamide, rubber-based thermoplastic polymers, e.g., butadiene-styrene copolymer, polymers obtained by polymerization or crosslinking of photopolymerizable or heat polymerizable compounds, e.g., epoxy compounds, and melamine compounds can be exemplified.

An inner adhesion modifying layer can be used to increase uniformity during the coating of subsequent layers and also increase the interlayer bonding strength between the other layers of the thermal transfer donor element and the donor support layer. One example of a suitable substrate with inner adhesion modifying layer is available from Teijin Ltd. (Product No. HPE100, Osaka, Japan).

The main support layer can be any material previously described as suitable as a support layer.

A light absorber can be included in the donor element to increase the amount of laser light absorbed in a layer of the donor element. The light absorber can take many forms, but typically is an efficient absorber of the laser light used for imaging, and preferably is a selective absorber. An efficient absorber can be used in small amounts, and a selective absorber will be unlikely to interfere with other optical properties such as color or transparency of the donor element and particularly the transfer layer.

Typically, the light absorber absorbs light in the infrared, visible, and/or ultraviolet regions of the electromagnetic spectrum, preferably as found in the imaging laser light. The light absorber is typically highly absorptive of the selected imaging laser light, providing an absorbance at a wavelength of the imaging laser light in the range of 0.2 to 3 in one embodiment, and from 0.5 to 2 in another embodiment. Absorbance is the absolute value of the logarithm (base 10) of the ratio of a) the intensity of light transmitted through the layer (typically in the shortest direction) and b) the intensity of light incident on the layer. For example, absorbance of 1 corresponds to transmission of 10% of incident light intensity; absorbance of greater than 0.4 corresponds to transmission of less than approximately 40% of incident light intensity.

Suitable light absorbing materials can include, for example, dyes (e.g., visible dyes, ultraviolet dyes, infrared dyes, fluorescent dyes, and light-polarizing dyes), pigments, metals, metal compounds, metal films, and other suitable absorbing materials. Examples of suitable light absorbers can include carbon black, graphite, metal oxides, metal sulfides, organic compounds such as cyanine based, polymethine based, azulenium based, squarylium based, thiopyrylium based, naphthoquinone based, or anthraquinone based dyes; and phthalocyanine based, azo based, or thioamide based organic metal complexes. Cyanine dyes are preferably used with infrared laser illumination, since they show a high absorption coefficient in the infrared region, and the thickness of a laser light absorbing layer can be thinned when used as the light-to-heat converting material, as a result, the imaging sensitivity of a donor element can be further improved.

The light absorber can be present in the transfer layer or another layer, for example a layer between the transfer layer and the support layer. A layer separate from the transfer layer comprising a light absorber can be termed a light-to-heat conversion layer, since during imaging with laser light the light absorber will absorb light and give off heat, but can be substantially or completely untransferred in contrast to absorber found in the imaged transfer layer in the imaged region of laser illumination.

The transfer layer can also comprise a number of layers or sublayers. The outer adhesion modifying layer of the transfer layer is typically a layer of adhesive coated as the outermost layer of the donor element transfer layer. The adhesive serves to promote complete transfer of the transfer layer, especially during the separation of the donor from the receiver after imaging. In one embodiment, the outer adhesion modifying layers includes colorless, transparent materials with a slight tack or no tack at room temperature, such as the family of resins sold by ICI Chemicals under the trade designation ELVACITE® (e.g., ELVACITE 2776).

Other conventional layers can be used in a donor element of the present invention, for example an interlayer or release layer as in U.S. Pat. No. 6,228,543 of Mizuno et al., a dynamic release layer as in U.S. Pat. No. 5,171,650 of Ellis et al., or an ejection layer as in U.S. Pat. No. 6,569,585 of Caspar et al., all incorporated herein by reference.

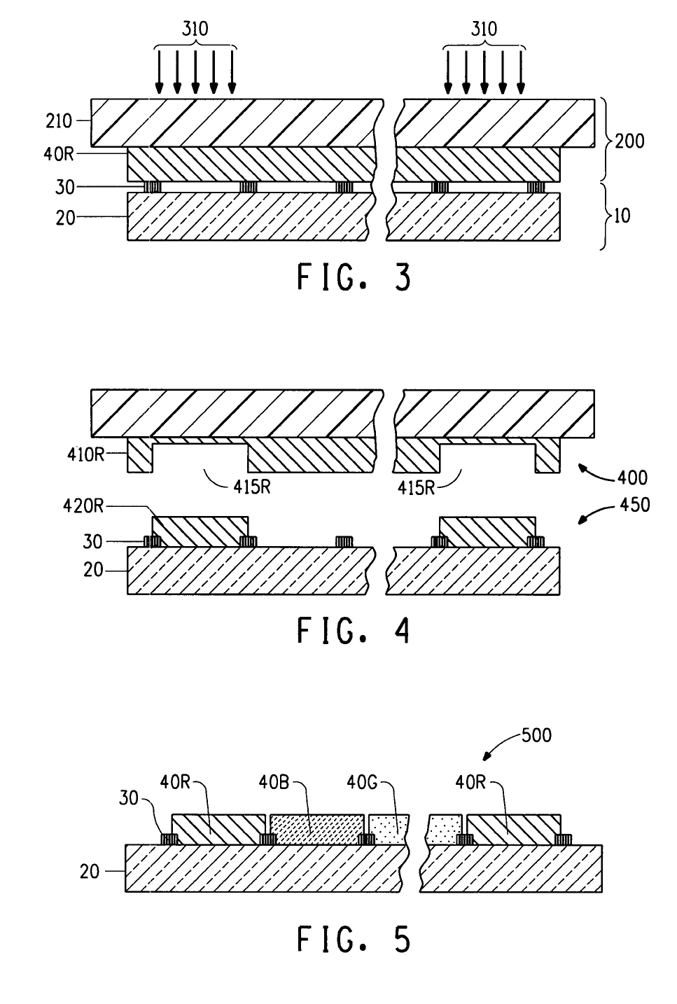

FIG. 3 shows an assemblage (300) of a donor element (200) adjacent and contacting a receiver element (10) of a glass substrate (20) and a black matrix (30). The donor element transfer layer (40R), itself supported on one side by the support layer (210), contacts the receiver element on its other side. A beam of laser light (310) images (illuminates an area of the donor element, and causes the transfer of adjacent transfer layer onto the receiver element) selected areas of the assemblage. The transfer layer on the receiver element as a result of the imaging by the beam of laser light is termed the laser-induced thermal transfer layer, since the temperature change induced by the laser is responsible for the transfer.

In the present invention, the donor element is typically contacted on the transfer layer side with a receiver element to form an imageable assemblage prior to imaging that is converted to an imaged assemblage after imaging. Contact may be partial or intermittent (FIG. 3) or continuous.

The receiver element may be any substrate suitable for the application of accepting the laser-induced thermal transfer layer including, but not limited to various papers, transparent films, liquid crystal display black matrices (as disclosed for example in U.S. Pat. No. 6,682,862, incorporated herein by reference), active portions of liquid crystal displays, color filter substrates, glasses, metals, etc. Suitable receiver elements are well known to those skilled in the art. Non-limiting examples of receiver elements which can be used in the present invention include anodized aluminum and other metals, transparent plastic films (e.g., polyethylene terephthalate), glass, and a variety of different types of paper (e.g., filled or unfilled, calendered, coated, etc.). Various layers (e.g., an adhesive layer) may be coated onto the image receiving substrate to facilitate transfer of the transfer layer to the receiver.

In at least some instances, pressure or vacuum is used to hold the donor element in contact with the receiver element in the assemblage. In one embodiment, a vacuum drum or vacuum table is used with the donor element and receiver element being of unequal area so as to allow the vacuum to draw air from between the donor and receiver elements of the assemblage and bring them into contact.

Prior to imaging, it is typical that construction of the assemblage of the donor element and receiver element is reversible. For example, upon release of the vacuum in the vacuum drum, the unchanged donor element and receiver element can be separated without damage.

The laser used for imaging preferably emits in the infrared, near-infrared or visible region. Particularly advantageous are diode lasers emitting in the region of 750 to 870 nm which offer a substantial advantage in terms of their small size, low cost, stability, reliability, ruggedness and ease of modulation. Such lasers are available from, for example, Spectra Diode Laboratories, San Jose, Calif. A laser head suitable for imaging is described in U.S. Pat. No. 6,682,862 to Youn-Gyoung Chang et al. assigned to LG. Phillips LCD Co., Ltd, incorporated herein by reference.

The assemblage is exposed to imaging light from an imaging laser, for example a suitable spatially modulated near-infrared laser, resulting in transfer of transfer layer from the donor element to the receiver element. To form an image, exposure can take place over a small region of the assemblage at any one time, so that transfer of material from the donor element to the receiver element can be built up one region at a time. Computer control of the writing laser produces imaging transfer with high resolution and at high speed. The assemblage, upon imagewise exposure to a laser, is termed an imaged assemblage.

Large donor elements can be used in the assemblage, including donor sheets that have length and width dimensions of a meter or more. In operation, a laser can be rastered or otherwise moved across the large assemblage, the laser being selectively operated to illuminate portions of the assemblage according to a desired pattern. Alternatively, the laser may be stationary and the assemblage moved beneath the laser, or both may be moved.

In one embodiment, the consequence of laser exposure causing imaging of the transfer layer is termed thermal mass transfer. Thermal mass transfer requires an essentially unchanged volume or “mass” of the transfer layer to be transferred onto the receiver, and is distinct from processes such as dye sublimation transfer that transfer only selective volatile or labile components rather than all components of a layer of a donor element to a receiver element, possibly across a gap, and melt transfer that requires melting of a component of the transfer layer such as a wax to allow flow of a liquefied or softened volume of the transfer layer into or onto a receiver layer in contact with the transfer layer. In one embodiment, thermal mass transfer occurs without contact of the adjacent donor element and the receiver element of the assemblage, as illustrated in FIG. 3 for transfer away from the black matrix (non-contacting thermal mass transfer). In another embodiment, thermal mass transfer occurs with contact of the donor element and the receiver element, as illustrated in FIG. 3 for the regions where the black matrix receives thermal transfer layer (contacting thermal mass transfer). In this embodiment, thermal mass transfer occurs both with and without contact of the donor element and the receiver element, in separate regions of the assemblage. One technique of obtaining thermal mass transfer is by ablation transfer as in U.S. Pat. No. 5,171,650 of Ernest W. Ellis et al., incorporated herein by reference.

After imaging and separation of the imaged assemblage, the resulting imaged receiver comprises the original receiver, that can be termed a receiver support, since it supports the imaged laser-induced thermal transfer layer, and the imaged laser-induced thermal transfer layer. Such an imaged receiver can be used in a subsequent assemblage with a donor element.

After imaging of the assemblage, the donor element is separated from the receiver element. This may be done by peeling the two elements apart. Very little peel force is typically required; the donor support layer may simply be separated from the receiver element. Any conventional manual or automatic separation technique may be used.

FIG. 4 shows the result of separation of the imaged assemblage. The spent donor element (400) includes the support layer (210) and a spent transfer layer (410R), depleted of laser-induced thermal transfer layer in the areas imaged. The depletion can be partial or complete. Depletion need not occur in all illuminated areas, and in some instances can occur outside of illuminated areas due to heat transfer or other causes. Imaged receiver element (450) includes the original receiver element (e.g. glass substrate (20) and black matrix (30)) and (imaged, transferred) laser-induced thermal transfer layer (420R) adjacent imaged areas. Imaging need not occur in all illuminated areas, and in some instances can occur outside of illuminated areas due to heat transfer or other causes.

In one embodiment, the receiver element is a color filter array substrate as is well known in the art. A typical color filter array substrate is a suitably transparent thin rectangular support of dimensions suitable for a liquid crystal display, for example glass, having a black matrix outlining the boundaries of many individual filters for converting white light into one of a colored light such as red, green, and blue, as can be produced for example by photolithography. Conventional methods for manufacturing a color filter substrate including the black matrix include a method in which chromium or chromium oxide is plated on the upper surface of a glass substrate and patterned, and a method in which a resin is spread on the upper surface of a glass substrate and patterned.

Color filters can be incorporated into functional active matrix liquid crystal display devices using techniques which are well known within the liquid crystal display industry (see, for instance “Fundamentals of Active-Matrix Liquid-Crystal Displays”, Sang Soo Kim, Society for Information Display Short Course, 2001; and “Liquid Crystal Displays: Addressing Schemes and Electro-optical Effects”, Ernst Lueder, John-Wiley, 2001; and U.S. Pat. No. 5,166,026, all incorporated herein by reference).

Individual filters with light transmitting dimensions of approximately equal to a 90 microns by 290 microns rectangle centered in a 100 by 300 micron area by a 5 micron black matrix serve as an example (FIG. 5). Filters are typically grouped so that neighboring filters can transmit colored light to produce the appearance of white light under appropriate circumstances to the viewer of a display incorporating the finished color filter array. U.S. Pat. No. 6,682,862, “Method of fabricating color filter substrate for liquid crystal display device” by Chang et al. assigned to LG. Philips LCD Co., Ltd., incorporated herein by reference, discloses a method of fabricating a color filter substrate for a liquid crystal display device that includes the steps of forming a black matrix on a substrate; adhering a color donor element to the substrate; disposing a laser head over the color donor element; repeatedly scanning the color donor element; and removing the color donor element so that a color filter pattern remains in color filter pattern regions defined inside the black matrix. U.S. Pat. No. 6,242,140, “Method for Manufacturing Color Filter” by Jang-hyuk Kwon et alia assigned to Samsung SDI Co, Ltd., incorporated herein by reference, discloses a method for manufacturing a color filter by thermal transfer using a laser beam. The method includes forming a black matrix pattern on a substrate by photolithography.

In one embodiment, a color filter can be made by three repetitions of making and imaging an assemblage, differing by using three differently colored donor elements, and a single color filter array substrate with all of its previously transferred color filters.

FIG. 5 shows a thrice imaged receiver element (500), incorporated into three separate assemblages with different donor elements, now comprising red laser-induced thermal transfer layer (40R), blue laser-induced thermal transfer layer (40B), and green laser-induced thermal transfer layer (40G) from those donor elements. An inorganic layer such as indium-tin oxide can be deposited onto the laser-induced thermal transfer layers and adjacent glass and black matrix to obtain the object of FIG. 1.

In FIG. 1, the indium-tin oxide coated color filter (10) comprises a transparent glass substrate (20) having an opaque black matrix (30) delineating pixels that selectively pass light by wavelength, covered by red laser-induced thermal transfer layer (40R), or blue laser-induced thermal transfer layer (40B), or green laser-induced thermal transfer layer (40G), as to filter out the other colors of white light when such light passes through each respective pixel. A layer of indium-tin oxide (50) covers and contacts glass, laser-induced thermal transfer layers, and black matrix.

An inorganic layer contains a metal (or metals), and is bonded to a laser-induced thermal transfer layer. Each metal may be a compound, alloy, in elemental form, or in a combination of forms. The inorganic layer may undesirably separate from the laser-induced thermal transfer layer due to temperature change that induces unequal dimensional changes in both the laser-induced thermal transfer layer and the inorganic layer. As a rule of thumb, inorganic layers have a lower coefficient of thermal expansion than laser-induced thermal transfer layers, that often comprise mainly organic materials such as binder, polymer, organic pigment or a combination of the preceding.

An indium-tin oxide layer (50) is representative of an inorganic layer, wherein the inorganic layer is composed in the majority of elemental or compounded metal or metals, oxygen, sulphur, nitrogen, chlorine, fluorine, bromine, and in the minority of carbon compounds and hydrogen compounds free of metals, by weight. The inorganic layer comprises a metal component, the metal of which can be selected from (but is not limited to) the group consisting of copper, silver, gold, iron, chromium, tin, indium, arsenic, antimony, aluminum, zinc, nickel, platinum, cobalt, silicon, and other metallic elements and combinations thereof, whether elemental or combined into a compound. A compound of the metal or metals in the inorganic layer may be oxide, sulphate, sulfide, nitrate, nitrite, carbonate, phosphate, chloride, bromide, fluoride, or combinations there of, but is not limited to such compounds.

In one embodiment, the inorganic layer is indium-tin oxide (ITO). Preferred are mixtures of indium (III) oxide and tin (IV) oxide in a ratio of about 80-99% by weight indium (III) oxide, more preferably 85 to 95% by weight indium (III) oxide, even more preferably about 90% by weight indium (III) oxide (74.4% In, 7.877% Sn, 17.8% O). A preferred ITO coating is visually transparent, transmitting most visible light without undue scattering, and conducts electricity. In one embodiment, the sheet resistance of the inorganic layer is less than 100 ohms per square as measured by a four point surface probe; particularly less than 50 ohms per square, more particularly less than 10 ohms per square, and even more particularly less than 5 ohms per square. In one embodiment, the transmittance of the inorganic layer is more than 80% at a wavelength of light of 680 nm; particularly more than 90%, and more particularly more than 95% transmittance.

In one embodiment, two steps are used to prepare a laser-induced thermal transfer layer for coating by an inorganic layer. The earlier step is exposing the laser-induced thermal transfer layer to ultraviolet radiation to produce an exposed transfer layer. The step performed subsequently is treating the exposed transfer layer with a cleaning fluid to produce a cleaned transfer layer. Ultimately, the inorganic layer is deposited in contact with the cleaned transfer layer to produce a deposited transfer layer. Other steps may be interspersed before, between, or after each step without necessarily removing the advantages of the exposing and treating steps.

In one embodiment, the exposing step of allowing the laser-induced thermal transfer layer to be illuminated by ultraviolet radiation is believed to chemically break down components of the layer in a step by step manner to smaller fragments, for example when the energy supplied by the ultraviolet radiation is sufficient to break chemical bonds or when oxygen is present that can be converted to atomic oxygen or ozone which then reacts with components of the layer. It is believed that the smaller fragments may react with oxygen, ozone, atomic oxygen, water, other fragments, or other components to eventually either erode away the layer or crosslink the layer, or both.

In previous methods of using ultraviolet treatment, treatment is short in time and mainly cleaning of contaminants on the surface of a substrate is accomplished. In previous methods of using ultraviolet treatment, the chemical nature of the substrate is seldom effected by the abbreviated treatment.

The ultraviolet light may be supplied by a lamp containing mercury, that typically emits ultraviolet radiation at about 185 and 256 nm wavelength in the ultraviolet wavelength region. Experimentation has shown that high energy ultraviolet radiation, such as 185 nm wavelength, is particularly suitable for the method of this invention. The mercury-containing lamps are easily obtained commercially. Another source of ultraviolet radiation is eximer lamps, for example those emitting at one of about 172 nm, 222 nm, or 282 nm (Heraeus Noblelight LLC, Duluth, Ga.). A third source of ultraviolet radiation is eximer lasers (Heraeus Noblelight LLC, Duluth, Ga.).

Suitable lamps are manufactured using clear fused quartz, synthetic fused silica, or doped fused silica (Heraeus Noblelight LLC, Duluth, Ga.) for transmission of the UV light. In a preferred embodiment, synthetic fused silica is used since the low level of non-silicon impurities maximizes the transmittance of desirable short wavelength, high energy ultraviolet radiation. A suitable grade of synthetic fused silica has at least 40% transmittance of ultraviolet radiation at 170 nm wavelength through a 1 cm thickness.

The time and energy of ultraviolet irradiation can be equipment dependent. For example, high energy ultraviolet radiation is absorbed by oxygen in air, that can cause creation of atomic oxygen and ozone which are potent reactive species. These reactive gases can be found close to the lamp, where the amount of ultraviolet irradiation is greatest before significant absorption by oxygen. To take advantage of the originally supplied ultraviolet radiation, it is preferred to have the laser-induced thermal transfer layer close to the radiation source, and it is preferred to allow the ultraviolet radiation pass through an atmosphere containing oxygen, more preferably in an atmosphere in contact with the layer. The oxygen can be provided by ambient air, dry air, or in the form of an oxygen-enhanced or depleted atmosphere, at ambient, reduced, or increased pressure. In one embodiment, the time and energy of the irradiation are chosen so as to minimally change a property of the layer: for example, the layer thickness can be decreased by less than 5%, or less than 2%, or less than 1%. Similarly, the color of a layer can be changed by less than 5%, or less than 2%, or less than 1%. In one embodiment at atmospheric pressure and atmosphere, a UV pathlength of about 0.3 to 3 cm can be used; more particularly 0.5 to 2 cm.

The time of ultraviolet irradiation can range from seconds through minutes to hours. A preferred irradiation time is from 10 seconds to 30 minutes; a more preferred irradiation time is from 5 to 15 minutes.

The energy of the ultraviolet irradiation can vary from 0.250 to 30 joules per square centimeter summed over the high energy wavelengths of less 220 nanometers, particularly in the case of a mercury lamp. Different limits may be found suitable for other wavelengths from other sources of ultraviolet radiation, e.g. those that suitably alter the laser-induced thermal transfer layer without appreciably changing the layer thickness or color.

The energy of the ultraviolet irradiation can vary from 2,000 to 500,000 microwatts per square centimeter at about 254 nanometers, or from 100 to 50,000 microwatts per square centimeter at about 185 nanometers, particularly in the case of a mercury lamp. More preferred is a lamp output of 28,000-35,000 microwatts per square centimeter at 254 nanometers, and about 1,500-2,500 microwatts per square centimeter at 185 nanometers. Different limits may be preferred for other wavelengths from other sources of ultraviolet radiation.

In one embodiment, it is preferred that the amount of ultraviolet radiation more energetic than 242 nm be at least a selection from 2 J/cm², 5 J/cm², 10 J/cm², 20 J/cm², 30 J/cm², and 40 J/cm², including radiation at about 185 nm. This radiation increases ozone production from oxygen. In another embodiment, the radiation more energetic than 242 nm can be supplemented by radiation less energetic than 242 nm and more energetic than 310 nm, being at least a selection from 20 J/cm^{2b , 50} J/cm², 100 J/cm², 200 J/cm², 300 J/cm², and 400 J/cm², including radiation at about 254 nm. Such radiation increases the atomic oxygen production from ozone.

The treatment of the exposed transfer layer by cleaning is believed to remove material generated from the transfer layer by the ultraviolet radiation exposure step. Solvent based and water based cleaning can both be expected to provide cleaning. Cleaning aids such as surfactants, antistats, soaps, emulsifiers, and other components commonly used for cleaning can be provided in the solvent or water base. In one embodiment, water and less than 5% by weight of surfactant are used. In another embodiment, a solvent is used in the cleaning step. The solvent may be one or more of methanol, ethanol, propanol, dichloromethane, dimethyl adipate, diethyl adipate, toluene, and N-methyl-2-pyrrolidone. A mixture of water and one or more solvents can be used. The treatment can include repetitive or different cleanings, for example a cleaning with water containing a surfactant followed by a cleaning with pure water. The cleaning can include a drying step, such a spinning, wiping, blowing, etc.

The treatment with a water based or solvent based cleaning fluid can involve agitation of the fluid or the laser-induced thermal transfer layer. Agitation of the fluid can encompass spraying, jetting, sheet-wise flow, or other well known methods. Agitation of the layer can encompass vibration, spinning, dipping, or other well known methods.

In some embodiments, it has been found that prompt depositing of an inorganic layer after cleaning is advantageous. For example, it is preferable to avoid any delay of over 24 hours; it is more preferable to avoid any delay of over 4 hours, and even more preferable to avoid any delay of over 1 hour between cleaning and depositing of the inorganic layer.

In some embodiments, it has been found that heat treatment of the laser-induced thermal transfer layer should be avoided between the UV exposure or cleaning step, and the depositing of the inorganic layer. For example, it is preferable to avoid any heat treatment of the laser-induced thermal transfer layer of more than 10 minutes at a temperature of more than 160 C; more preferable to avoid any heat treatment of more than 5 minutes at a temperature of more than 120 C; and even preferable to avoid any heat treatment of more than 1 minute at a temperature of more than 60 C after the UV exposure and after the cleaning and before the inorganic layer deposition step.

The depositing of an inorganic layer in contact with the cleaned transfer layer can be by any common deposition technique, for example one selected from the group consisting of direct current magnetron sputtering, ion beam deposition, radio frequency (RF) sputtering, RF magnetron sputtering, chemical vapor deposition, ion beam enhanced deposition, laser ablation deposition, electron beam evaporation, physical vapor deposition, ion beam sputtering, ion-assisted deposition, reactive sputtering, and other known techniques. Such techniques can be performed in vacuum, at reduced pressure in the presence of gases such as oxygen, argon, nitrogen, fluorine, hydrogen, or air, or at ambient pressure in the presence of the same gases. Suitable techniques are described in the background, description, and claims of U.S. Pat. Nos. 6,849,165, 6,821,655, 6,425,990, 6,121,178, and 5,185,059, all incorporated herein by reference, in “Properties of ITO thin films deposited on amorphous and crystalline substrates with e-beam evaporation”, by R. X. Wang et al., in Semiconductor Science & Technology, Volume 19 No 6 (June 2004) 695-698, incorporated herein by reference, and in “Super-smooth indium-tin oxide thin films by negative sputter ion beam technology”, by M. H. Sohn, et al., in Journal of Vacuum Science and Technology A, volume 21 part 4 July/August 2003, incorporated herein by reference.

The thickness of the inorganic layer deposited is determined by the intended use of the inorganic layer. In one embodiment, the thickness can be as thin as 0.020 microns or thinner; in another embodiment, the thickness can be as thick as 10 microns or thicker. In one embodiment using indium-tin oxide, thickness of 20 to 2000 nanometers is appropriate; for example 40 to 200 nanometers.

### EXAMPLES

The following examples illustrate certain features and advantages of the present invention. They are intended to be illustrative of the invention, but not limiting. All percentages, ratios, and parts are by weight, unless otherwise indicated.

The typical substrate used for demonstrating the importance of the steps of the method was a color filter made from a glass panel bearing a black matrix defining color filter subpixels, each subpixel covered by one of a red, green, or blue transfer layer applied by laser thermal transfer. Subpixels were arranged in a stripe pattern, where three subpixels and associated black matrix area made up a pixel approximately 300 microns by 300 microns in size.

A typical range of composition of the colored transfer layer of 1-3 microns in thickness, applied as an aqueous formulation, was:

37-55 dry parts by weight of a first styrene-acrylic copolymer with carboxylic acid content of 3.6 mM/g and weight average molecular weight about 10,000 atomic mass units

30-55 dry parts of one or more pigment dispersions with pigment to binder ratio of 1.5-4:1 by weight

0-6 dry parts of a second styrene-acrylic copolymer with carboxylic acid content of 3.6 mM/g and weight average molecular weight about 4000

6-10 dry parts of carboxylic acid crosslinker

1-1.5 dry parts of near-IR-absorbing dye 2-[2-[2-Chloro-3[2-(1,3-dihydro-1,1dimethyl-3-(4-dimethyl-3-(4-sulfobutyl)-2H-benz[e]indol-2-yllidene)ethylidene]-1-cyclohexen-1-yl]ethenyl]-1,1-dimethyl-3-(sulfobutyl)-1H-benz[e]indolium,inner salt,free acid, CAS #[162411-28-1] peak absorbance about 850 nM, from H. W. Sands and Co., Jupiter, Fla.

0.5 parts surfactant

0.5 parts defoaming agent

Laser thermal imaging used a rapidly moving, blinking infrared laser at a fluence of approximately 400 mJ/cm² and exposure time of less than 5 μs. A suitable imager is the Creo Spectrum Trendsetter 3244F (CREO, Burnby, BC, Canada), which utilizes lasers emitting near 830 nm. This device utilizes a Spatial Light Modulator to split and modulate the 5-50 Watt output from the ˜830 nm laser diode array. Associated optics focus this light onto the imageable elements. This produces 0.1 to 30 Watts of imaging light on the donor element, focused to an array of 50 to 240 individual beams, each with 10-200 mW of light in approximately 10×10 to 2×10 micron spots. Similar exposure can be obtained with individual lasers per spot, such as disclosed in U.S. Pat. No. 4,743,091. In this case each laser emits 50-300 mW of electrically modulated light at 780-870 nm. Other options include fiber coupled lasers emitting 500-3000 mW and each individually modulated and focused on the media. Such a laser can be obtained from Opto Power in Tucson, Ariz.

After laser thermal imaging and removal of the spent transfer layer donor element, the color filter element was heated, for example to 200 C for 1 hour, to anneal the laser-induced thermal transfer layer.

Ultraviolet light exposure of the color filter was accomplished with a UVO Cleaner Model 384 available from JELight, Irvine, Calif. with a high intensity low-pressure mercury vapor grid lamp for optimum generation of atomic oxygen and ozone. The color filter was 10 mm from the ultraviolet bulb. Ambient atmosphere was used. UV light at 185 and 254-579 nanometers was supplied by a Suprasil low pressure mercury grid lamp, with lamp output of 28,000 microwatts per square centimeter at 254 nanometers, and about 2,400 microwatts per square centimeter at 185 nanometers. An ozone-free mercury grid lamp supplied UV light at 254-579 nanometers with insignificant light energy at 185 nanometers. Documented are exposures by the lamp of around 6 and 10 minutes. This corresponds to about 540-1,500 millijoules at 185 nanometers. It is believed that sufficient energy needs to be supplied to change the surface characteristics of the laser-induced thermal transfer layer, and that such changes may begin at or around 250 millijoules for wavelengths less than 220 nanometers. Higher energies may eventually unacceptably erode the laser-induced thermal transfer layer, determining an upper limit for exposure energy. In some cases some erosion may be acceptable, especially since the cleaning treatment can remove residues of erosion. For this reason, it is believed that energies of up to 30 joules for wavelengths less than 220 nanometers may be useful in this method. Other lower and upper limits may be suitable; for example a combination of a lower limit selected from one of 300, 350, 500, and 1000 millijoules, and an upper limit selected from one of 1.5, 5, 10, and 20 joules. The time of exposure can be varied within reasonable limits; for example a selection of a minimum time from 1, 2, 5, or 10 minutes, and a maximum time selected from 15, 20, 30, or 60 minutes.

Cleaning after ultraviolet light exposure was accomplished by aqueous washing. In one instance, washing was carried out as follows: the sample was set spinning at 80 rpm; for 20 seconds the sample was sprayed at high pressure (about 3000 psi, 2 E8 dynes/sq-cm) with deionized water, then for 30 seconds the sample was brushed under a flow of aqueous surfactant; then for 60 seconds the sample was brushed under a flow of deionized water; then for 65 seconds the sample was sprayed at high pressure with deionized water; then for 60 seconds the sample was sprayed with deionized water through a nozzle vibrated at about 1.5 mHz (megasonic cleaning); then for 60 seconds the sample was brushed with hot deionized water. The spinning rate of the sample was increased to 700 rpm, and then the sample was dried for 30 seconds under a flow of nitrogen. The spinning rate of the sample was increased to 1000 rpm, and then the sample was dried for 40 seconds under a flow of nitrogen, and then the sample was dried for 20 seconds without a nitrogen flow, at which point the washing step was complete and the spinning was stopped.

Indium-tin oxide (ITO) deposition was done at reduced pressure and elevated temperature under conditions similar to those in U.S. Pat. No. 6,242,140 by Kwon, et al., to Samsung SDI Co., Ltd. Upon cooling of the color filter with ITO coating, the ITO-coated color filter was inspected for minute wrinkles indicative of shrinking of the laser-induced thermal transfer layer causing buckling of the ITO layer (wrinkle inspection). Quality due to wrinkling was rated from 0 (severe wrinkling) to 5 (no wrinkling).

Durability testing of the ITO coating was by (1) subjecting the ITO-coated color filter to steam in a pressure cooker at 120 C for 2 hours, (2) cooling the ITO-coated color filter, (3) cutting a crosshatch pattern of one hundred squares 1 mm on each side in a 10 by 10 pattern through the ITO/laser-induced thermal transfer layer interface, (4) covering the crosshatch pattern with adhesive tape (Scotch brand M610, 3M, Minneapolis, Minn.), (5) removing the adhesive tape and (6) observing the pattern for any delamination of ITO from laser-induced thermal transfer layer and laser-induced thermal transfer layer from glass. When damage was visible between step 2 and 3, further testing was unnecessary.

A Tencor P-15 Stylus profilometer (KLA-Tencor, San Jose, Calif.) was used to measure the height (nm) of transferred material or ITO and determine surface roughness values that are reported as Rq (roughness quotient) in nm.

Color of the transferred layer was measured using an Ocean Optics diode spectrophotometer (Ocean Optics, Dunedin, Fla.).

### Example 1

A glass color filter substrate with photolithographically-defined organic-resin-based black matrix was laser imaged sequentially with a first set of blue, red and green laser-induced thermal transfer layers, annealed at 230 C for 45 minutes in air, UV treated in air using the suprasil lamp for 8 minutes (˜13 joules per centimeter squared at ˜254 nm), washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The ITO-coated color filter passed the durability testing-smoothness and adhesion were excellent. Surface roughness after ITO deposition (4 separate color filters) of red filter windows was <10 nm, of green was <18 nm, and of blue was <20 nm. This example serves to show the excellent performance under appropriate UV exposure and cleaning treatment.

### Comparative Example 2

### No UV Treatment

A glass color filter substrate with photolithographically-defined organic-resin-based black matrix was laser imaged sequentially with a first set of blue, red and green laser-induced thermal transfer layers, annealed at 230 C for 45 minutes in air, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. No UV treatment was used. The ITO-coated color filter showed delamination from the glass in the durability testing. Surface roughness after ITO deposition (2 separate color filters) of red filter windows was 14-18 nm, of green was 22-26 nm, and of blue was 20-25 nm. This example shows that adhesion suffers by skipping the UV exposure.

### Example 3

A glass color filter substrate with photolithographically-defined organic-resin-based black matrix was laser imaged sequentially with a second set of blue, red and green laser-induced thermal transfer layers, annealed at 230 C for 60 minutes in air, UV treated in air using the suprasil lamp for 6 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 4.

### Example 4

A glass color filter substrate with photolithographically-defined organic-resin-based black matrix was laser imaged sequentially with a second set of blue, red and green laser-induced thermal transfer layers, annealed at 230 C for 60 minutes in air, UV treated in air using the ozone-free lamp (negligible 185 nm, 254 nm region similar to example 3) for 6 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 2. This example shows that all UV treatments are not alike; Example 3 in comparison to Example 4 shows that higher energy UV can improve smoothness (decrease wrinkling).

### Example 5

A glass color filter substrate with photolithographically-defined organic-resin-based black matrix was laser imaged sequentially with a second set of blue, red and green laser-induced thermal transfer layers, annealed at 230 C for 60 minutes in air, UV treated in air using the suprasil lamp for 8 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 5.

### Example 6

A glass color filter substrate with photolithographically-defined organic-resin-based black matrix was laser imaged sequentially with a second set of blue, red and green laser-induced thermal transfer layers, annealed at 230 C for 60 minutes in air, UV treated in air using the ozone-free lamp (negligible 185 nm) for 8 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 4.5. This example in comparison with example 5 shows that higher energy UV is preferable.

### Example 7

A glass color filter substrate with photolithographically-defined organic-resin-based black matrix was laser imaged sequentially with a second set of blue, red and green laser-induced thermal transfer layers, annealed at 230 C for 60 minutes in air, UV treated in air using the suprasil lamp for 10 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 5. This example shows that higher doses of high energy UV can give a good result.

### Comparative Example 8

A glass color filter substrate with photolithographically-defined organic-resin-based black matrix was laser imaged sequentially with a second set of blue, red and green laser-induced thermal transfer layers, UV treated in air using the ozone-free lamp for 6 minutes, annealed at 230 C for 60 minutes in air, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The color filter quality due to wrinkling was rated 2. This example shows that a UV treatment lacking high energy radiation can be unsatisfactory.

### Comparative Example 9

A glass color filter substrate with photolithographically-defined organic-resin-based black matrix was laser imaged sequentially with a third set of blue, red and green laser-induced thermal transfer layers, annealed at 230 C for 60 minutes in air, UV treated in air using the suprasil lamp for 10 minutes, and ITO coated without washing after UV treatment. The ITO-coated color filter failed the durability test due to adhesive tape pick-off of ITO from laser-induced thermal transfer layer. This example shows the superiority of including the cleaning treatment. This failure mode was seen for various amounts of UV treatment duration.

### Example 10

A glass color filter substrate with photolithographically-defined organic-resin-based black matrix was laser imaged sequentially with a third set of blue, red and green laser-induced thermal transfer layers, annealed at 230 C for 60 minutes in air, UV treated in air using the suprasil lamp for 10 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, and ITO coated. The ITO-coated color filter passed the durability test. This example shows that three different sets of three different colors of laser-induced thermal transfer layers give a useful result using the inventive method.

### Example 11

A glass color filter substrate with photolithographically-defined organic-resin-based black matrix was laser imaged sequentially with a third set of blue, red and green laser-induced thermal transfer layers, UV treated in air using the suprasil lamp for at least 6 minutes, washed with water having 2% Micro-90 915E Cleaning Fluid (International Products, Inc, Burlington, N.J.), using a double-sided substrate cleaner such as a PSC 605 (Ultra T Equipment, Fremont, N.J.—this system uses high-pressure water jets with pressures of up to 13.8 megapascal or 2000 PSI, an 0.2 micron point-of-use filter, and 3 spin speeds), dried, annealed (heated) at 230 C for 60 minutes in air, and ITO coated. The ITO-coated color filter failed the durability test. This example shows that heat treatment between the UV or the cleaning step and the inorganic layer deposition can have a deleterious result on adhesion.

What is claimed is:

1. A method for depositing an inorganic layer to a thermal transfer layer comprising:
exposing a laser-induced thermal transfer layer to ultraviolet radiation to produce an exposed transfer layer,
treating the exposed transfer layer with a cleaning fluid to produce a cleaned transfer layer, and
depositing an inorganic layer in contact with the cleaned transfer layer to produce a deposited transfer layer.

2. The method of claim 1, wherein the exposing step is performed with ultraviolet radiation that exposes the laser-induced thermal transfer layer to energy of greater than 0.5 joule per square centimeter and less than 15 joules per square centimeter, totaled over all wavelengths of less than 242 nanometers.

3. The method of claim 1, wherein the exposing step is performed with ultraviolet radiation that exposes the laser-induced thermal transfer layer to energy of greater than 5 joules per square centimeter and less than 300 joules per square centimeter, totaled over all wavelengths of greater than 242 nanometers and less than 310 nanometers.

4. The method of claim 1, wherein the ultraviolet radiation is provided from a mercury lamp.

5. The method of claim 1, wherein the ultraviolet radiation is transmitted through synthetic fused silica of a mercury lamp.

6. The method of claim 1, wherein the exposing step is performed for a total time between 2 and 20 minutes.

7. The method of claim 1, wherein the exposing step is carried out in an atmosphere comprising oxygen.

8. The method of claim 1, wherein the exposing step is carried out in an atmosphere comprising ozone.

9. The method of claim 1, wherein the inorganic layer has a sheet resistance of less than 100 ohm per square.

10. The method of claim 1, wherein the inorganic layer has a transmissivity for light at 680 nanometers wavelength of more than 90% transmittance.

11. The method of claim 1, wherein the inorganic layer comprises a metal selected from the group consisting of copper, silver, gold, iron, chromium, tin, indium, arsenic, antimony, aluminum, zinc, nickel, platinum, cobalt, and combinations thereof.

12. The method of claim 1, wherein the inorganic layer comprises indium.

13. The method of claim 1, wherein the inorganic layer comprises tin.

14. The method of claim 1, wherein the inorganic layer comprises a metal oxide, the metal selected from the group consisting of copper, silver, gold, iron, chromium, tin, indium, arsenic, antimony, aluminum, zinc, nickel, platinum, cobalt, and combinations thereof.

15. The method of claim 1, wherein the depositing step is performed by a method selected from the group consisting of direct current magnetron sputtering, ion beam deposition, radio frequency sputtering, radio frequency magnetron sputtering, chemical vapor deposition, ion beam enhanced deposition, laser ablation deposition, electron beam evaporation, physical vapor deposition, ion beam sputtering, ion-assisted deposition, reactive sputtering, and combinations thereof.

16. The method of claim 1, wherein the cleaning fluid comprises water.

17. The method of claim 1, wherein the cleaning fluid comprises a surfactant.

18. The method of claim 1, wherein the cleaning fluid comprises a solvent.

19. The method of claim 18, wherein the solvent is selected from the group consisting of methanol, ethanol, propanol, dichloromethane, dimethyl adipate, diethyl adipate, toluene, and N-methyl-2-pyrrolidone and combinations thereof.

20. The method of claim 1, wherein the transfer layer is disposed on a receiver element and comprises a first color, and a second transfer layer of a second color is disposed on the receiver element and a third transfer layer of a third color is disposed on the receiver element, the first, second and the third colors being different.

21. The method of claim 1, wherein the transfer layer contains a binder comprising a polymer having a plurality of carboxyl functionality.

22. The method of claim 1, wherein the transfer layer contains a binder comprising a plurality of crosslinkable functional groups that react with crosslinking funtionality.

23. The method of claim 22 wherein the crosslinking functionality is hydroxyl.

24. The method of claim 22 wherein the crosslinking functionality is N-2-hydroxyethyl amide.

25. The method of claim 1, wherein the transfer layer is heated to at least 1700 Celsius prior to exposing the transfer layer to ultraviolet radiation.

26. The method of claim 1, further comprising the step of incorporating the deposited transfer layer into a display.

27. The method of claim 26, wherein the display is selected from the group consisting of a liquid crystal display, a plasma display, a light-emitting diode display, and combinations thereof.

28. The method of claim 1, wherein the transfer layer contacts a transparent substrate.

29. The method of claim 28, wherein the transparent substrate comprises glass.

30. The method of claim 28, wherein the transfer layer contacts a black matrix.

31. The method of claim 1, wherein the laser-induced thermal transfer layer is maintained at less than 60° C. when the time period between the exposing and the depositing steps is greater than one minute.

32. A deposited transfer layer made by the method of claim 1.
